(19) United States
(12) Patent Application Publication
(10) Pub. No.: US 2014/0227894 A1
(43) Pub. Date: Aug. 14, 2014

(54) PLUG CONNECTION PART

(71) Applicant: Dominik Schweizer, Schwerzenbach (CH)

(72) Inventor: Dominik Schweizer, Schwerzenbach (CH)

(73) Assignee: REICHLE & DE-MASSARI AG, Wetzikon (CH)

(21) Appl. No.: 14/241,470

(22) PCT Filed: Aug. 16, 2012
(86) PCT No.: PCT/EP2012/003480

§ 371 Date: Feb. 27, 2014

(30) Foreign Application Priority Data
Sep. 2, 2011 (CH) 01447/11

(51) Int. Cl. H01R 13/6461

(52) U.S. Cl. CPC H01R 13/6461
USPC 439/131; 439/620.15

(57) ABSTRACT

A plug connection socket includes a plurality of resilient socket contacts which are exposed in a socket opening and with which corresponding plug contacts of a data plug can make contact at third contact points. The socket also has a first conductor track support with first conductor tracks which are in electrical contact with the socket contacts via first contact points and which have a compensation structure in order to compensate crosstalk. These first conductor tracks are situated in a contact supporting wall which runs axially parallel to the contacts and against which at least some of the socket contacts are pressed when a plug is inserted. Second contact points are present on a second conductor track support. In addition to the second contact points and suitable connection contacts for the conductive cores, the second conductor track support also has second conductor tracks which form a second crosstalk compensation structure.

The invention relates to the field of plug connectors for electrical data transmission. Said invention relates, in particular, to a plug connection part, specifically a plug connection socket.

Plug connectors of the standard RJ45 type or corresponding Cat. 7 plugs are commonly used for data transmission via twisted conductor pairs (“twisted pair”). More stringent requirements are continually placed on achievable data transmission rates. In particular, the crosstalk between conductor tracks which distorts the signals has been found to be limiting. It is therefore known, in particular for sockets of plug connections which meet relatively stringent requirements (for example Cat. 6 or higher), to provide a crosstalk compensation means (crosstalk compensation circuit; ‘crosstalk compensation’) in the socket.

U.S. Pat. No. 7,686,650 discloses a plug connection socket for Cat. 6A plug connections. Whereas in conventional Cat. 6 sockets, the crosstalk compensation means adjoins the socket contacts at the socket end (that is to say signals arriving from the plug are initially routed through the socket contacts—which are parallel to one another and resilient—and then enter the compensation circuit), U.S. Pat. No. 7,686,650 teaches a different arrangement. The crosstalk compensation means is accommodated on a flexible printed circuit which is suspended from the free ends of the socket contacts.

However, one disadvantage of this known arrangement is the flexible printed circuit which is firmly held only by solder points and which is exposed to the risk of contact being interrupted on account of different forces on the individual contacts when a plug is inserted. Furthermore, the high assembly costs and costs of the flexible printed circuit are considered to be advantageous in arrangements of this kind.

A solution without a flexible printed circuit is disclosed, for example, in WO 2011/025527. However, one disadvantage of this solution is that the additional contact which is required for this solution is very complicated and is formed from several different components. This likewise results in comparatively high manufacturing and assembly costs.

The objective of the present invention is to provide a plug connection socket which overcomes disadvantages of the prior art and which is suitable, in particular, for Cat. 6 and or Cat. 6A and also, if need be, Cat. 7 and/or Cat. 7A plug connections.

This objective is achieved by the invention as defined in the patent claims.

A first aspect of the invention provides a plug connection socket (in particular of a standard plug connection) for electrical data transmission. The plug connection socket has a plurality of resilient socket contacts which are exposed in a socket opening and with which corresponding plug contacts of a data plug can make contact at third contact points. The socket also has, in a manner known per se, a first conductor track support with first conductor tracks with which the socket contacts can make contact at first contact points (contact is permanent or contact is made only when a plug is inserted) and which have a compensation structure in order to compensate crosstalk. According to one aspect of the invention, these first conductor tracks are situated in a contact supporting wall which runs axially parallel to the contacts and against which at least some of the socket contacts are pressed when a plug is inserted.

In this case, the first conductor track support can itself form the contact supporting wall or can be fitted on the inside of the—in this case separate—contact supporting wall. By way of example, the conductor track support can be in the form of a rigid printed circuit board (PCB) or, by virtue of its arrangement, can form the cover of an (internal) contact housing.

The first contact points of the socket contacts to the conductor tracks of the first conductor track support can be at the socket contact end, that is to say the third contact points to the plug contacts are then located between the first contact points to the conductor tracks of the first conductor track support and the second contact points to the data cables which are connected to the socket.

The second contact points are present on a second conductor track support. In addition to the second contact points and suitable connection contacts for the conductor cores which are connected to the socket, the second conductor track support can also have second conductor tracks which form a second crosstalk compensation structure. The plug connection socket then has a two-stage compensation structure. The second conductor track support can function as the component which supports the socket contacts, that is to say the socket contacts are mechanically held and fixed by the second conductor track support. In this case, the second contact points are also in the form of connection points for the socket contacts.

The two-stage compensation may be advantageous, in particular, in combination with a construction in which the first contact points are arranged on the socket contact ends, that is to say further away from the first contact points than the third contact points to the plug contacts. In a case of this kind, the third contact points are arranged between the (first) conductor tracks of the (first) crosstalk compensation means and the second conductor tracks of the second crosstalk compensation means. The parallel free regions of the socket contacts are therefore bounded on both sides by a crosstalk compensation means; this type of two-stage compensation has proven to be particularly advantageous. On the path from the conductor cores which are connected to the socket, the signal initially passes through the second compensation means and then a portion of the socket contacts, from where it is tapped off by means of the third contact points and coupled into the plug. However, it is also coupled into the first compensation structure by the first contact points, as a result of which (further) contributions to undesired coupling along the parallel socket contacts can be compensated for.

The second conductor track support can be oriented, in particular, transversely, that is to say perpendicular to the plug socket axis.

The socket contacts are integral and parallel to one another and form, without auxiliary contacts or supporting auxiliary means, a direct connection between the first contact points and the second contact points, without branching or transposition. Said socket contacts run, for example, between the first contact points and the second contact points in a substantially arcuate manner, wherein the third contact points are defined along the arc, for example on a shortest possible path.

The socket contacts are preferably of identical or substantially identical design. There may be, for example, eight socket contacts which all (possibly with the bend which is required for the spring action) run along a common plane, as is known per se from the contact part of socket contacts of RJ45 sockets.

The procedure according to the invention with parallel socket contacts and the two-stage compensation allows the use of socket contacts which are cost-effective to manufacture and simple to assemble, while maintaining the Cat. 6 and/or Cat. 6A performance.

The first contact points between the socket contacts and the conductor tracks of the conductor track support can be formed, as is known per se, by solder points. However, it is also feasible to use electrically conductive adhesives or other connections, for example clamping connections. As a further option, the contact points are formed by connection contact surfaces of the first conductor track support, the socket contacts not being fastened to said connection contact surfaces but the socket contacts being pressed against said connection contact surfaces when a plug is inserted. In this case, in the state in which a plug is not inserted, the socket contacts are in contact with the connection contact surfaces, or else not. Provision can further be made for the socket contacts to slide locally on the contact surfaces when a plug is inserted.

As is known per se, the socket can have an inner contact housing (socket housing) which supports the contacts, and also an outer socket housing which, for example, forms the socket opening. The contact housing can have, for example, in addition to the axial contact supporting wall (cover), a proximally adjoining transverse wall which delimits the socket opening in the plugging direction. The two conductor tracks which form the second crosstalk compensation means can run in the transverse wall or parallel to said transverse wall.

The position identifiers ‘transverse’ (perpendicular to the plugging axis), ‘axial’ (parallel to the plugging axis), proximal (toward the socket side), distal (toward the plug side) used here or further positions do not provide any information about the orientation with which the plug connection is intended to be used.

An exemplary embodiment of the invention will be described in detail below with reference to figures. In the figures, identical reference symbols denote identical or analogous elements. In the drawing:

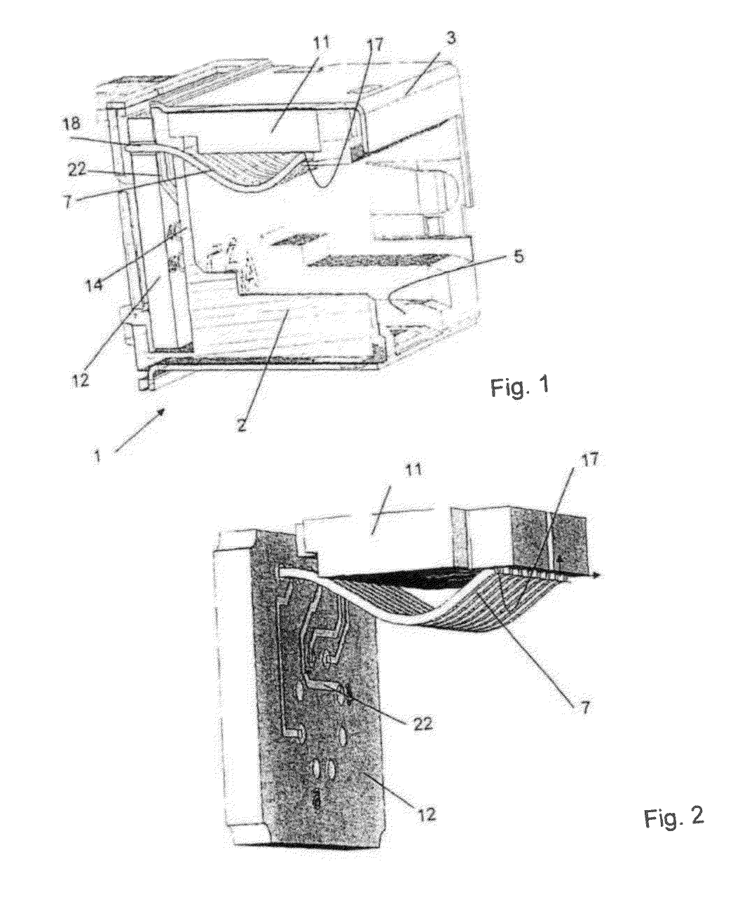

FIG. 1 shows a sectional illustration through part of a socket according to the invention;

FIG. 2 shows an illustration of elements of a socket according to FIG. 1;

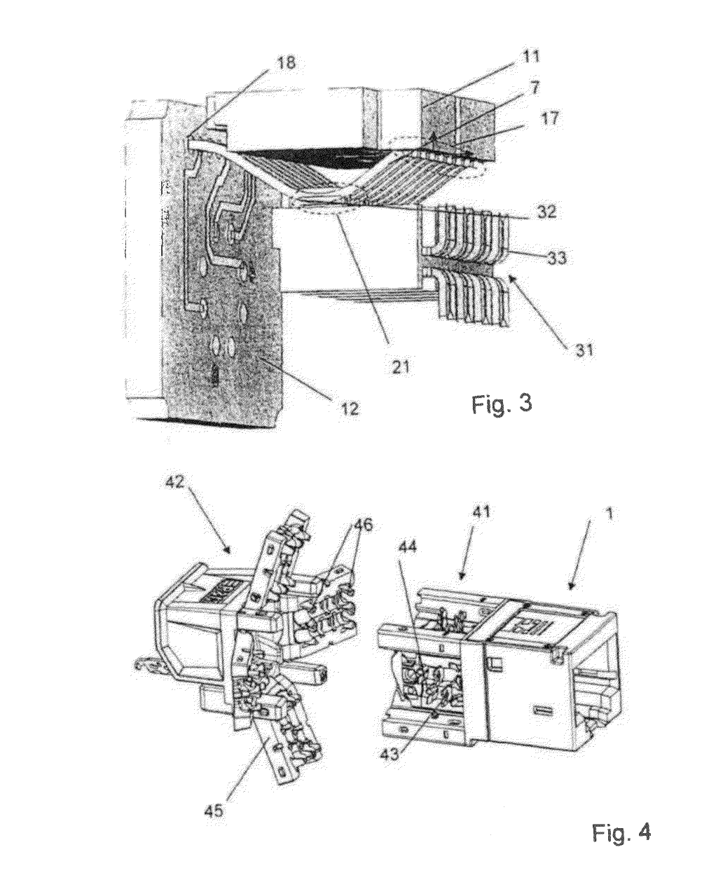

FIG. 3 shows an illustration according to FIG. 2 with an indicated contact part of an RJ45 plug; and

FIG. 4 shows a view of a socket with a connection block.

The socket, of which a detail is shown in FIG. 1, is part of a plug connection of the RJ45 type and meets the requirements of Cat. 6A (ISO) with a transmission performance according to IEC60603-7-41/-51. Only the front (distal) part, or contact part 1, of the socket is illustrated in FIG. 1. Said part has an inner housing 2 (or socket frame) and also an outer housing 3. The inner housing 2 and the outer housing 3 together form the socket in which a socket opening is formed. A matching plug can be inserted into said socket opening. The inner and/or outer housing—the outer housing in the illustrated exemplary embodiment—also have/has a latching projection 5 behind which a corresponding latching means of the plug (for example a detent) can latch.

Eight parallel, resilient socket contacts 7 are present at the top (in relation to the orientation stated in the figure). The socket contacts run along a common plane, which may mean that the start and end points of the parallel contacts span a single common plane.

If a plug is inserted into the socket opening, plug contacts make contact with the resilient socket contacts and, in the process, said resilient socket contacts are deflected against the spring force—upward in FIG. 1. In this case, an axial contact supporting wall partially absorbs the forces which act on the socket contacts 7. In the illustrated example, the contact supporting wall itself is in the form of a (first) printed circuit board 11 which functions as the first conductor track support. It would also be possible, in principle, for the first conductor track support, for example in the form of a flexible printed circuit, to bear against an, in this case, separate contact supporting wall, or for the contact supporting wall to be of multipartite design and to be formed by a printed circuit board and a board element which is separate from said printed circuit board, or the like. The illustrated construction, in which the printed circuit board itself also functions as the mechanical support means, is particularly simple.

The (plug-side, distal) contact ends of the socket contacts 7 are in contact with first contact points 17 (here in the form of contact surfaces) of the first printed circuit board 11 at least when a plug is inserted. The socket-side (proximal) contact ends of the socket contacts 7 are in contact with conductor tracks of the second printed circuit board 12 at second contact points 18 (in this case in the form of connection points). The second contact points 18, which also mechanically hold the socket contacts and serve as connection points, are formed by electrically conductively coated through-openings in the second printed circuit board 12 into which the contact ends are soldered. Other solutions are also feasible, for example a clamping fit etc.

In addition or as an alternative, the socket contacts 7 can have an end part, which is of reduced diameter and projects into the associated opening, at their end which is directed toward the second contact points 18 and/or a collar at a distance from the end, so that a shoulder is formed, said shoulder resting on the distal flat side of the second printed circuit board 12 and thus supporting the resilient socket contacts in the event of mechanical loading on the printed circuit board.

FIG. 1 also shows that the contacts are integral and parallel, run without transposition and directly, without auxiliary contacts or the like, connect the conductor tracks of the first printed circuit board to the third contact points with the plug and to the conductor tracks of the second printed circuit board.

Adjoining the second contact points 18, the socket contacts 7 initially run approximately perpendicularly away from the second conductor track support and then in an arc, which is directed toward the plug, to the first contact points 17. The third contact points are located on the arcuate part and, therefore, between the first and the second contact points. In comparison to this, known socket contacts are designed such that they initially run along the housing interior or in the housing interior from the proximal side to the distal end (which is on the outside in relation to the socket opening) and then from this end to the proximal side and are bent in relation to the plug, so that the free socket contact ends are located in the socket opening and can yield in a resilient manner when the plug is inserted. A change in direction of this kind in relation to the axial direction is not provided in the illustrated embodiment. Whereas this is not precluded in a socket according to the invention, the socket contacts are considerably shorter in the construction of the illustrated type, this contributing to reducing crosstalk.

In the direction toward the proximal side, (that is to say toward the left-hand side in FIG. 1), the socket opening is terminated by a transverse wall 14 of the inner housing. The second printed circuit board 12, which accommodates the plug-side end of the socket contacts and makes contact with said end by means of conductor tracks, runs substantially parallel to said transverse wall.

FIG. 2 shows the first printed circuit board 11 which forms the contact supporting wall, the second printed circuit board 12, and also the socket contacts with an orientation which is slightly different to that in FIG. 1 and without an outer housing and parts of the inner housing.

FIG. 3 shows a view which is comparable to FIG. 2, wherein a contact block 31 of a plug, which is inserted into the socket, is additionally shown. The plug has eight plug contacts 33 which each have an insulation-displacement terminal for plug-side conductor cores to make contact and a contact part, which is at the top in FIG. 3, which is pressed onto the corresponding socket contact at the third contact points 21 and deforms and makes contact with said socket contact. In the process, the socket contacts 7 can be pressed against the first contact points 17, wherein a radial deflection in the direction of the first contact points (provided that contact is not already made with these in the starting state) and/or an axial deflection in the distal direction can take place, this being illustrated in FIG. 3 by corresponding arrows.

FIG. 4 also shows, in addition to the contact part 1 of the socket, a connection part 41 which serves for connection of the socket-side conductor cores. In the illustrated embodiment, the connection part 41 has connection means which pass through the insulation of the cable, in this case insulation-displacement terminal contacts 43. In each case one insulation-displacement terminal contact is—not shown in FIG. 4—electrically connected to in each case one of the second contact points, for example by a plug connection or a solder connection. In the shown exemplary embodiment, there are in each case two insulation-displacement terminals 43—in each case with an associated strain-relief means 44 here—on each of the four (lateral) sides of the connection part. This has the advantage that conductor cores are arranged in the region, in which they are no longer twisted, as far away as possible from conductor cores which do not belong to the same pair of conductor cores. A wiring part 42 has four wiring covers 45 which can be folded laterally in the direction of the connection part 41 and which each have a core guide 46 for the conductor cores. For connection purposes, the data cable can be routed from the proximal side, through an axial opening (not shown in FIG. 4 on account of the orientation in the illustration) of the wiring part and the untwisted, no longer twisted, ends of the cores can be inserted into the core guide 46. Once the wiring part 42 and the connection part have been brought together, the wiring covers are each placed on one side of the connection part, as a result of which the conductor cores are inserted into the intended strain-relief means and the intended insulation-displacement terminal.

It goes without saying that other wiring and connection techniques with or without contacts which pass through the insulation are also feasible, for example insulation-displacement terminal contacts without the wiring covers, piercing contacts, solder points, clamping contacts etc., in each case with or without guide means for the cable cores. The geometric configuration with two connection means for each side is also only one of several possibilities.

A large number of further embodiments are also feasible for the contact part 1. For example, it is not necessary for there to be an inner housing and an outer housing. Instead, the contact housing can also be of integral design or designed in some other way. It is also possible to design the socket as a whole to be integral, that is to say it is not necessary to split up the contact part and connection part.

1. A plug connection socket for electrical data transmission, comprising:
a socket housing with a socket opening for inserting a matching data plug;
a plurality of resilient socket contacts which are exposed in the socket opening and with which corresponding plug contacts of the data plug can make contact at third contact points;
a first conductor track support with first conductor tracks and first contact points, wherein the socket contacts can make contact with the first conductor tracks at the first contact points and the first conductor tracks have a first compensation structure in order to compensate crosstalk, wherein the first conductor tracks are situated in a contact supporting wall which runs axially parallel to the contacts and against which at least some of the socket contacts are pressed when a plug is inserted; and
a second conductor track support with second conductor tracks and second contact points, wherein the socket contacts make contact with the second conductor tracks at the second contact points and the second conductor tracks have a second compensation structure in order to compensate crosstalk,
wherein the socket contacts are integrally formed and parallel to one another and make direct electrical contact with the first and the second contact points, and
wherein the socket contacts run such that the third contact points are arranged between the first contact points and the second contact points.

2. The plug connection socket according to claim 1, wherein the first contact points are formed by connection contact surfaces of the first conductor track support, the socket contacts being pressed against said connection contact surfaces when a plug is inserted.

3. The plug connection socket according to claim 2, wherein the socket contacts are not in contact with the connection contact surfaces when no plug is inserted.

4. The plug connection socket according to claim 1, wherein the second contact points are formed by through-openings in the second printed circuit board, the ends of the socket contacts being soldered into said openings.

5. The plug connection socket according to claim 1, wherein the second conductor track support is fitted transversely to the plugging axis, in that the second contact points for the socket contacts are formed by openings in the second conductor track support, the socket contacts being also mechanically held in said openings, and in that the socket contacts run from the second conductor track support, in an arc which is directed toward the plug, to the first contact points.

6. The plug connection socket according to claim 1, wherein all of the socket contacts are of substantially identical design.

7. (canceled)

8. The plug connection socket according to claim 1, wherein
the first conductor track support and the second conductor track support are part of an inner housing which supports the socket contacts, and
the plug connection socket further has an outer housing which at least partially surrounds the inner housing.

9. The plug connection socket according to claim 1, wherein all of the socket contacts are arranged in a common plane.

10. The plug connection socket according to claim 1, wherein the first conductor track support and the second conductor track support are each formed by a dimensionally rigid printed circuit board.

11. The plug connection socket according to claim 2, wherein the second contact points are formed by through-openings in the second printed circuit board, the ends of the socket contacts being soldered into said openings.

12. The plug connection socket according to claim 3, wherein the second contact points are formed by through-openings in the second printed circuit board, the ends of the socket contacts being soldered into said openings.

13. The plug connection socket according to claim 2, wherein the second conductor track support is fitted transversely to the plugging axis, in that the second contact points for the socket contacts are formed by openings in the second conductor track support, the socket contacts being also mechanically held in said openings, and in that the socket contacts run from the second conductor track support, in an arc which is directed toward the plug, to the first contact points.

14. The plug connection socket according to claim 3, wherein the second conductor track support is fitted transversely to the plugging axis, in that the second contact points for the socket contacts are formed by openings in the second conductor track support, the socket contacts being also mechanically held in said openings, and in that the socket contacts run from the second conductor track support, in an arc which is directed toward the plug, to the first contact points.

15. The plug connection socket according to claim 4, wherein the second conductor track support is fitted transversely to the plugging axis, in that the second contact points for the socket contacts are formed by openings in the second conductor track support, the socket contacts being also mechanically held in said openings, and in that the socket contacts run from the second conductor track support, in an arc which is directed toward the plug, to the first contact points.

16. The plug connection socket according to claim 2, wherein all of the socket contacts are of substantially identical design.

17. The plug connection socket according to claim 3, wherein all of the socket contacts are of substantially identical design.

18. The plug connection socket according to claim 4, wherein all of the socket contacts are of substantially identical design.

19. The plug connection socket according to claim 5, wherein all of the socket contacts are of substantially identical design.

20. The plug connection socket according to claim 2, wherein
the first conductor track support and the second conductor track support are part of an inner housing which supports the socket contacts, and
the plug connection socket further has an outer housing which at least partially surrounds the inner housing.

21. The plug connection socket according to claim 3, wherein
the first conductor track support and the second conductor track support are part of an inner housing which supports the socket contacts, and
the plug connection socket further has an outer housing which at least partially surrounds the inner housing.
